(19) United States
(12) Patent Application Publication
(10) Pub. No.: US 2013/0258414 A1
(43) Pub. Date: Oct. 3, 2013

(54) IMAGE PROCESSING APPARATUS AND CONTROL METHOD THEREOF

(71) Applicant: CANON KABUSHIKI KAISHA, Tokyo (JP)

(72) Inventor: Kyohei Kikuta, Tokyo (JP)

(73) Assignee: CANON KABUSHIKI KAISHA, Tokyo (JP)

(21) Appl. No.: 13/829,909

(22) Filed: Mar. 14, 2013

(30) Foreign Application Priority Data
Mar. 29, 2012 (JP) 2012-076772

(51) Int. Cl. G06K 15/02

(52) U.S. Cl. CPC G06K 15/1876
USPC 358/3.14

(57) ABSTRACT

An image processing apparatus for generating a dot pattern by halftone processing using a plurality of threshold matrices, the apparatus comprising a first tone group including at least a pair of discontinuous tone levels, and a second tone group including tone levels different from the tone levels included in the first tone group, wherein, in each of the first tone group and the second tone group, a dot pattern representing each tone level includes all the dots representing brighter tone level.

### BACKGROUND OF THE INVENTION

1. Field of the Invention

The present invention relates to an image processing apparatus and a control method thereof. More specifically, the present invention relates to a dither method using a threshold matrix.

2. Description of the Related Art

An image forming apparatus for forming an image on a recording medium using dots is often used as an apparatus for outputting an image processed by a personal computer and an image captured by a digital camera. A tone number capable of being output by such an image forming apparatus is generally less than a tone number of image data used by, for example, the personal computer. Therefore, it is required to provide halftone processing of the image data to change the tone number thereof to the tone number capable of being output by the image forming apparatus.

The dither method is known as one of the halftone processing methods. In the dither method, pixel values representing input image data are compared with a threshold of a threshold matrix per pixel, thereby determining an output value of each pixel. There is a problem that a sufficient graininess cannot be obtained from the dither method. The problem results from a cause that the graininess is affected by a dot disposition of the other tone levels in the dither method despite of a difference in an optimum dot disposition according to the tone level (i.e., the brightness).

Japanese Patent Application Laid-Open No. 2003-46777 discusses a method for preliminarily storing optimum dot patterns of all of the tone levels. According to a tone level of input image data, a dot pattern is selected from the stored dot patterns. Referring to whether the corresponding pixel positions in the selected dot pattern are ON dots or OFF dots to determine an output of each pixel. In this method, each of the dot patterns of all the tone levels is stored separately. Therefore, a dot disposition having better graininess can be determined for each tone level without being limited by dot dispositions of the other tone levels.

Japanese Patent Application Laid-Open No. 2003-46777 also discusses an example to perform the dither method by using a threshold matrix with respect to a portion of a continuous-tone section. The method enables saving of a storage capacity in comparison with the above described method for storing the dot patterns of all the tone levels. However, the method for assigning the portion of the continuous-tone section to the piece of threshold matrix as discussed in Japanese Patent Application Laid-Open No. 2003-46777 is affected by the dot dispositions of the other tone levels in the continuous-tone section similar to the conventional dither method. Therefore, there is a problem that a dot pattern having good graininess cannot always be generated.

### SUMMARY OF THE INVENTION

The present invention is directed to an image processing apparatus and a control method thereof capable of generating a dot pattern having good graininess by the dither method using a threshold matrix while saving a required storage capacity.

According to an aspect of the present invention, an image processing apparatus for generating a dot pattern of each tone level so that, in a tone level N, a tone level N+α, and a tone level N+β (α<β), a dot pattern representing the tone level N+β includes all the dots in a dot pattern representing the tone level N and a dot pattern representing the tone level N+α does not include all the dots in the dot pattern representing the tone level N, includes a halftone processing unit configured to perform halftone processing on an input tone level by using a threshold matrix to generate a dot pattern representing the input tone level, wherein the dot patterns representing the tone level N and the tone level N+β are generated by the halftone processing using a first threshold matrix, and wherein the dot pattern representing the tone level N+α is generated by the halftone processing using a second threshold matrix different from the first threshold matrix.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating configurations of an image processing apparatus and an image forming apparatus.

FIG. 2 is a block diagram illustrating a halftone processing unit 206 in the image processing apparatus in detail.

FIG. 3 is a block diagram illustrating the halftone processing unit 206 in the image processing apparatus in detail.

FIG. 4 is a flow chart illustrating a series of processing performed in the halftone processing unit 206.

FIG. 5 is a schematic diagram of a dot pattern illustrating tone levels having “good match”.

FIG. 6 is a schematic diagram illustrating a conventional typical dither method.

FIG. 7 is a diagram illustrating tone levels corresponding to a threshold matrix in a first exemplary embodiment.

FIG. 8 is a schematic diagram illustrating a degree of freedom of a dot disposition.

FIG. 9 is a flow chart illustrating how to create a plurality of threshold matrices.

FIG. 10 is a graph illustrating a relationship between a storage capacity required for storing a plurality of threshold matrices and a storage capacity required for storing dot patterns of all of the tone levels.

FIG. 11 is a diagram illustrating an example of correspondence between tone values and a plurality of threshold matrices.

FIG. 12 illustrates a specific example of a plurality of threshold matrices.

FIG. 13 is a schematic diagram illustrating a state of dots to be output for each of the tone values.

FIG. 14 illustrates states of dots to be output for each threshold matrix.

### DESCRIPTION OF THE EMBODIMENTS

Various exemplary embodiments, features, and aspects of the invention will be described in detail below with reference to the drawings.

Configurations described in the following exemplary embodiments are mere examples and thus the present invention is not restricted to the illustrated configurations.

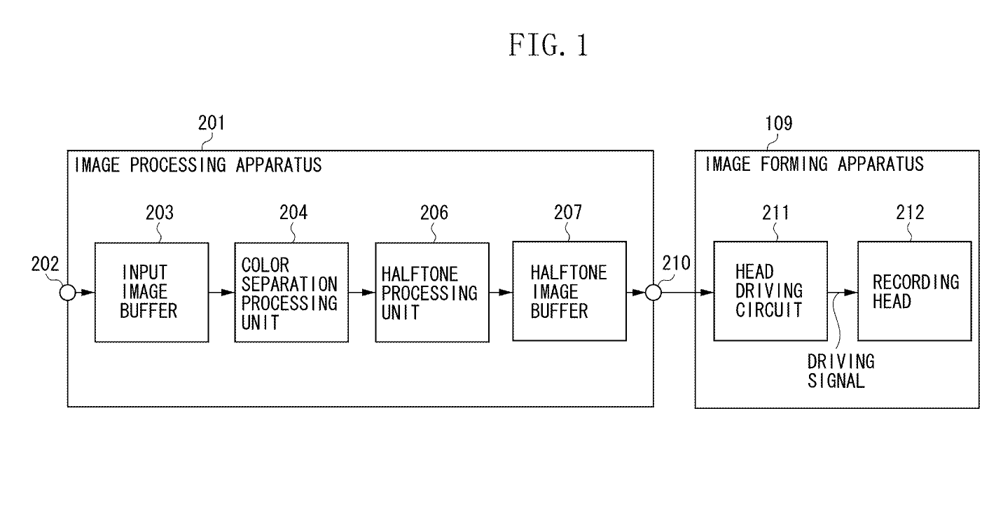

FIG. 1 is a block diagram illustrating configurations of an image processing apparatus and an image forming apparatus according to an first exemplary embodiment. In FIG. 1, an image processing apparatus 201 and an image forming apparatus 109 are connected to each other via an interface or a circuit. The image processing apparatus 1 is, for example, a printer driver installed in a general personal computer. In this case, a function of each unit within the image processing apparatus 1 described below is realized by a computer executing a predetermined program. However, such a configuration that the image forming apparatus 2 includes the image processing apparatus 1 may also be employable.

The image processing apparatus 201 stores color image data to be printed (hereinbelow, referred to as “input color image data”) input via an input terminal 202 into an input image buffer 203. Thus, input color image data includes three color components such as red (R), green (G), and blue (B).

A color separation processing unit 204 decomposes the stored input image data into image data corresponding to colors of color materials equipped in the image forming apparatus 109. In the color separation process, a look up table for color separation (not illustrated) is referred to. In the present exemplary embodiment, a color of black (K) is exemplified for the description. In a case where a color image is formed on a recording medium, the color separation process may be performed to separate the image data into a plurality of colors such as cyan (C), magenta (M), yellow (Y), and black (K). In the present exemplary embodiment, the data after subjecting to the color separation process is treated as 8 bit data representing 256 tone levels ranging from 0 to 255. The data may be converted into data having tone number equal to or larger than 256 tone levels.

A halftone processing unit 206 performs halftone processing by using a plurality of threshold matrices on the color separation processed data obtained from a color separation processing unit 204. A threshold matrix to be used in the plurality of threshold matrices is determined according to an input value (i.e., a tone level) representing a pixel. The color separation processed 8-bit data is converted into 1 bit (i.e., binary) data. The halftone processing is described below in detail. The halftone processing unit 206 outputs halftone image data to a halftone image buffer 207. The stored halftone image data is output to the image forming apparatus 109 via an output terminal 210.

The image forming apparatus 109 forms an image on a recording medium by moving a recording head 212 vertically and horizontally relative to the recording medium based on the halftone-processed image data received from the image processing apparatus 201. A recording head 201 is of an ink jet type and includes more than one recording element (i.e., more than one nozzle).

A head driving circuit 211 generates a driving signal for controlling the recording head 212 based on the halftone image data. The recording head 212 actually records each ink dot onto the recording medium based on the driving signal.

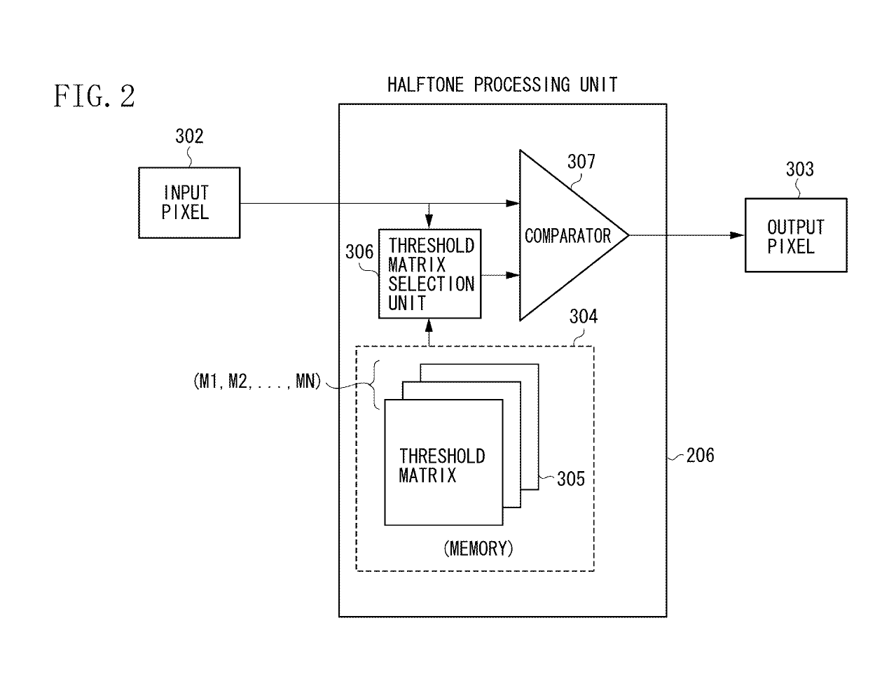

The halftone processing unit 206 according to the present exemplary embodiment is described below in detail. FIG. 2 is a block diagram illustrating a configuration of the halftone processing unit 206 in detail. The halftone processing unit 206 converts the color separation processed data of 256 tone levels output from the color separation processing unit 204 into binary (i.e., 1-bit) data.

More specifically, an output value is determined by comparing an input value representing a target pixel 302 with a threshold in the corresponding threshold matrix. The halftone processing unit 206 includes a memory 304, a threshold matrix selection unit 306, and a comparator 307. The memory 304 stores a plurality of mutually different threshold matrices 305 (M1, M2, . . . , MN).

The threshold matrix selection unit 306 determines one threshold matrix to be used from the plurality of threshold matrices 305 according to the input value for each pixel. The comparator 307 compares a threshold in the threshold matrix selected by the threshold matrix selection unit 306 corresponding to a target pixel with a pixel value of the target pixel to determine an output value.

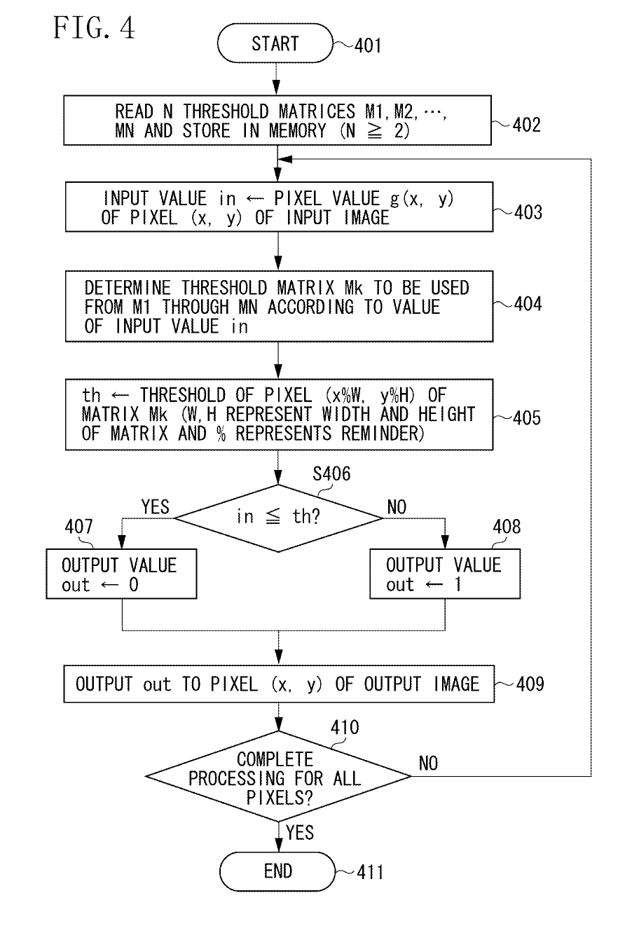

FIG. 4 is a flow chart illustrating a series of processing performed in the halftone processing unit 206. A halftone processing method according to the present exemplary embodiment is described below.

In step S402, the image processing apparatus 201 reads preliminarily prepared N threshold matrices as initialization processing.

In step S403, the halftone processing unit 206 reads a pixel value g(x, y) representing the target pixel (x, y) to record it as a variable (in) representing an input value.

In step S404, the threshold matrix selection unit 306 determines a threshold matrix to be used by the comparator 307 among the plurality of threshold matrices (i.e., M1 through MN) stored on the memory according to the input value “in”. The correspondence relation between the input values “in” and the threshold matrix to be used is preliminarily determined and held in the form of a table. The threshold matrix selection unit 306 can determine the threshold matrix by referring the table. The correspondence relation between the input values “in” and the threshold matrix is described below in more detail. The threshold matrix to be used is represented by Mk.

In step S405, the comparator 307 reads a position corresponding to a position (x, y) of the target pixel in the threshold matrix Mk selected by the matrix selection unit 306. The reading of the position corresponding to the target pixel in the threshold matrix is performed according to a method similar to the conventional dither method. A position (i, j) corresponding to the target pixel in the threshold matrix is determined by i=x % W and j=y % H. Here, % represents a reminder, and W and H represent, respectively, a width and a height of the threshold matrix. The comparator 307 stores the threshold stored at the position (i, j) in the threshold matrix Mk in a variable “th”.

In step S406, the comparator 307 compares the input value “in” and the threshold “th”. In a case where the input value “in” is equal to or smaller than the threshold “th” (YES in step S406), the processing proceeds to step S407. On the other hand, in a case where the input value in is larger than the threshold “th” (NO in step S406), the processing proceeds to step S408. In step S407, the comparator 307 stores an output value “out” of the target pixel as 0. On the other hand, in step S408, the comparator 307 stores the output value “out” of the target pixel as 1. In other words, 0 (i.e., black) is output when the input value “in” is equal to or smaller than the threshold “th”. Otherwise, 1 (i.e., white) is output.

In step S409, the halftone processing unit 206 outputs the output value “out” to the position (x, y) of the output image.

In step S410, the above described processing is performed on all the pixels in the input image, and when the processing is completed on all the pixels (YES in step S410), in step S411, the halftone processing is ended.

The correspondence relationship between the input values (i.e., the tone levels) and the threshold matrix to be used is described below in detail. As described above, an optimum dot disposition where a satisfactory good graininess can be obtained in each tone level differs one by one. Therefore, each tone level is related to the threshold matrix so that a dot disposition (i.e., a dot pattern) having good graininess representing each tone level can be obtained.

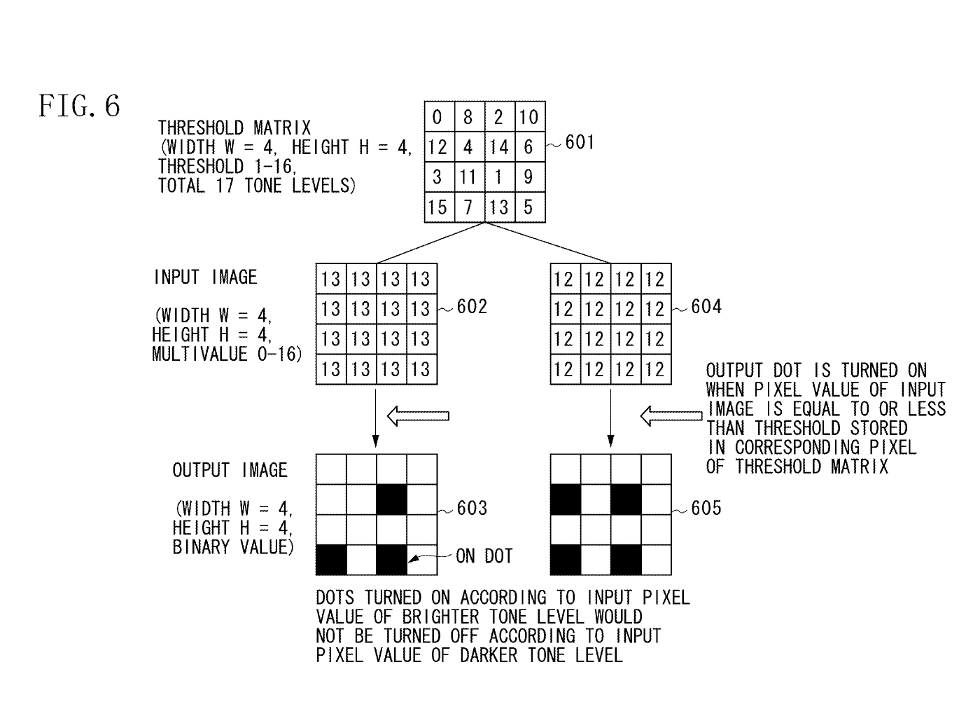

A feature of the dither method using the threshold matrix is described below. FIG. 6 illustrates a typical dither method. A threshold matrix 601 has a width of W=4, a height of H=4, and each pixel stores one threshold selected from “0 through 15”. The threshold matrix to be used is one sheet.

In other words, independent from the input values, the threshold matrix 601 is used. In a case where the input pixel value is smaller than the threshold, an ON dot (i.e., black pixel) is output, whereas in a case where the input pixel value is larger than the threshold, an OFF dot (i.e., white pixel) is output. Therefore, in a case where the threshold matrix 601 is used, a dot pattern of 17 tone levels can be obtained.

An input image 602 has uniform pixel values 13 and has the same size as 4 as that of the threshold matrix 601. When the output values are determined by using the threshold matrix 601 with respect to the input image 602, the output image 603 can be obtained.

On the other hand, with respect to an input image 604 having uniform pixel values 12 of which input image is slightly darker than the input image 602, when the output values are determined by using the threshold matrix 601, an output image 605 can be obtained. At that time, the output image 605 includes all the ON dots of the output image 603 representing brighter tone levels than ON dots (i.e., black pixels) of the output image 605. As described above, according to the conventional dither method, dots converted into ON dots (i.e., black pixels) with the brighter tone levels would not become OFF dots (i.e., white pixels) with tone levels darker than the above described tone levels.

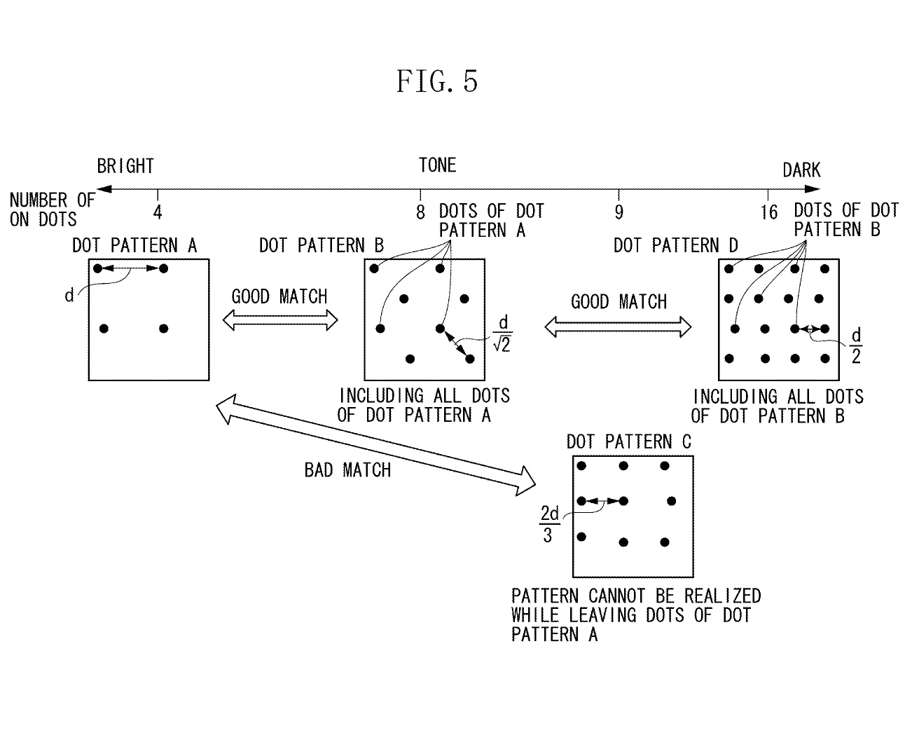

However, since the optimum dot patterns differ in each tone level, if the dots are fixed in the bright tone level, the tone level in which the optimum dot pattern cannot be set is generated. Dot patterns A, B, C, and D in FIG. 5 are dot patterns representing, respectively, tone levels 4, 8, 9, and 16. The dot patterns are configured so that good graininess can be obtained in each tone level.

As seen from the number of black dots, the dot patterns A, B, C, and D represent the brighter tone levels in this order. The dot pattern B includes all the dots included in the dot pattern A. The dot pattern D includes all the dots included in the dot pattern B. As a result thereof, the dot pattern D includes all the dots included in the dot pattern A.

As described above, a case where a dot pattern including more dots includes all the dots included in a dot pattern including fewer dots or has a relationship similar thereto, is expressed as in “good match”. More specifically, among the dot patterns illustrated in FIG. 5, the dot patterns A, B, and D can be considered as being in “good match” to each other.

Namely, a tone level 8 can realize a dot pattern having good graininess while leaving dots of a tone level 4 therein, and a tone level 16 can realize a dot pattern having good graininess while leaving dots of the tone level 4 or dots of the tone level 8 therein.

On the other hand, the dot pattern C includes almost no dots in the dot pattern A including less dots. Similarly, almost no dots in the dot pattern C are included in the dot patterns B and D including many dots. Therefore, the dot pattern C is not considered as being in “good match” with the other dot patterns A, B, and D. More specifically, the tone level 9 cannot realize a dot pattern having good graininess while leaving dots of the dot pattern A therein.

As described above, in the dither method using the threshold matrix, the dots once converted into ON dots (i.e., black pixels) in the brighter tone level would not become OFF dots (i.e., white pixels) in the tone level darker than the tone level thereof. Therefore, the dot patterns A, B, and D having mutual “good match” illustrated in FIG. 5 can be realized by the dither method using a threshold matrix. In the present exemplary embodiment, in a case where a dot disposition by which a sufficient graininess can be obtained for a certain tone level is set, tone levels having dot patterns mutually in good match is related to the same threshold matrix as much as possible.

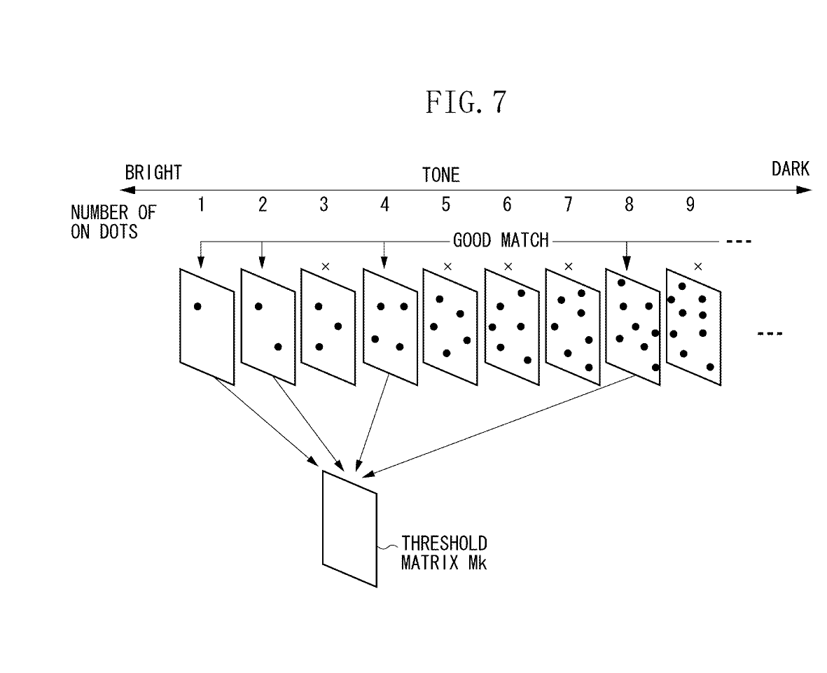

FIG. 7 schematically illustrates a correspondence relationship between a threshold matrix and tone levels. As described above, when the threshold matrix is designed in consideration of the matching between the tone levels, as illustrated in FIG. 7, the tone levels to which one threshold matrix corresponds is not a continuous section but is a discrete tone levels. It is set so that all the input values (i.e., all the tone levels) corresponds to any one of the threshold matrices. A method for creating the threshold matrix according to the present exemplary embodiment is described below.

The memory 304 in the halftone processing unit 206 stores a plurality of threshold matrices created according to a method described below.

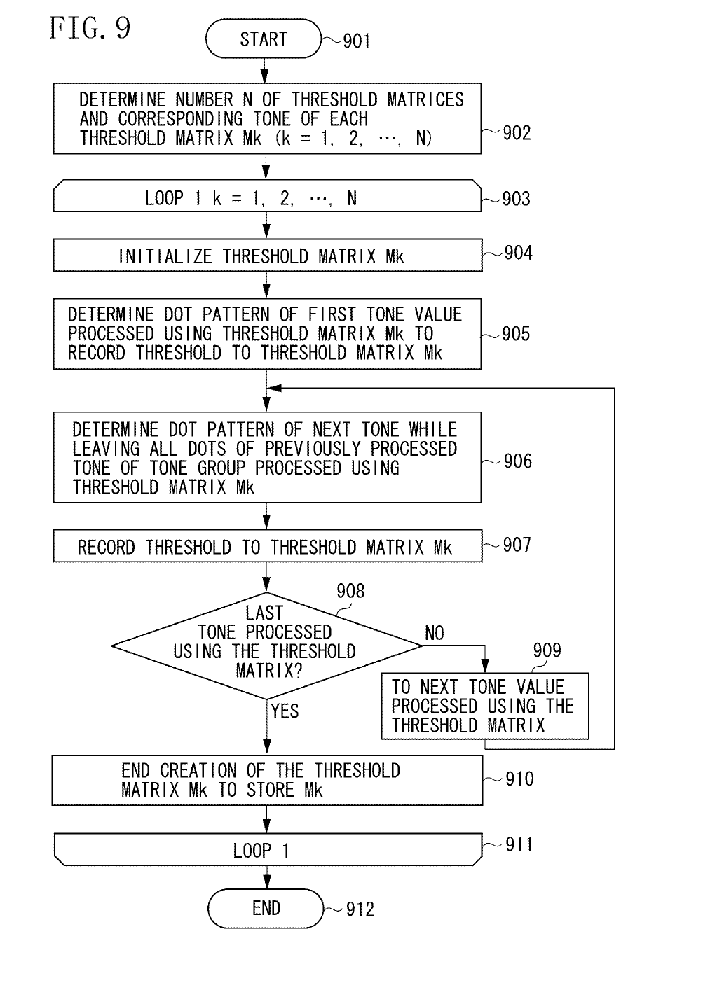

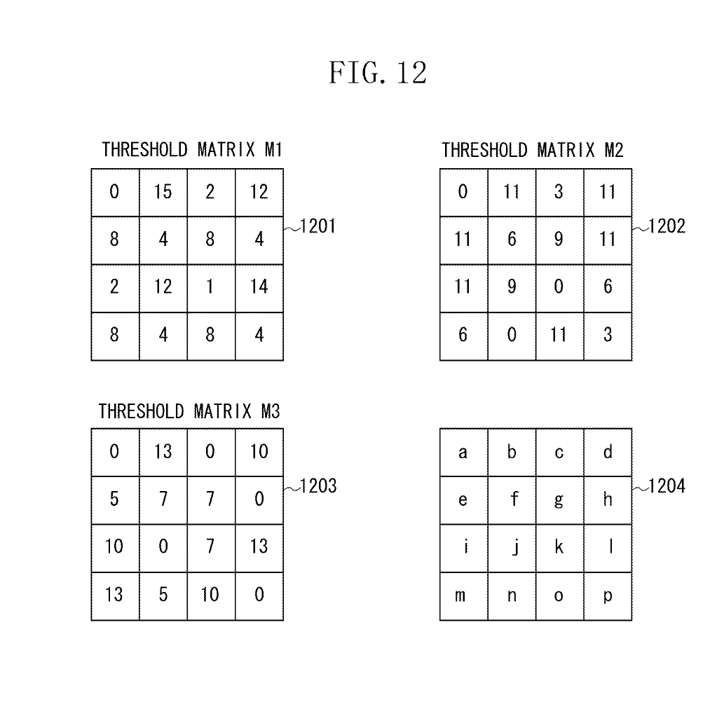

FIG. 9 is a flow chart illustrating how to create the threshold matrix. For the sake of simple description, a threshold matrix having a width of W=4 and a height of H=4 as a matrix 1204 illustrated in FIG. 12 is created as an example. Each threshold has any one of the values 0 through 15. Input image data is represented by a 4 bit-16 tone levels. In other words, in a 4×4 matrix, 17 tone levels ranging from 0 (i.e., black in a whole area) to 16 (i.e., white in a whole area) can be represented.

In step S902, the number N of the threshold matrices to be created and a tone group to be processed by each threshold matrix Mk (k=1, . . . , N) are determined. Here, the number N of the threshold matrices is set to 3 and each of the threshold matrices is defined as M1, M2, and M3. In other words, three threshold matrices are created.

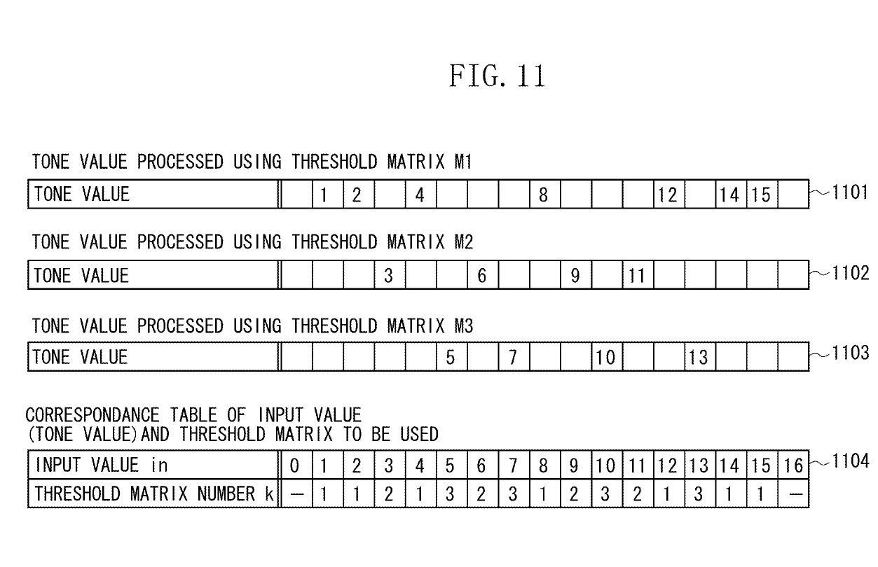

Further, the input value (i.e., the tone value) to be processed by each threshold matrix is set as illustrated in FIG. 11. A correspondence table 1104 in FIG. 11 includes input values (i.e., tone levels) in an upper row and a number k of the threshold matrix Mk corresponding to each tone level in a lower row.

For example, the threshold matrix M1 is used for an input value representing a tone level 1 and a threshold matrix M3 is used for an input value representing a tone level 5.

Each of tables 1101 through 1103 represents tone levels processed by each of the threshold matrices M1, M2, and M3. The correspondence table 1104 is a synthesis of the tables 1101 through 1103.

A group of tone levels corresponding to each threshold matrix is referred to as a tone group. In other words, the tone group corresponding to the threshold matrix M1 is tone values 1, 2, 4, 8, 12, 14, and 15. All the threshold matrices correspond to a tone group including discontinuous tone levels. Here, the discontinuous tone levels mean tone levels 2, 4, 8, 12, and 14. Each tone level group includes tone levels different from the tone levels included in the other tone level groups.

In the present exemplary embodiment, the tone levels having good match to each other is initially related to the threshold matrix M1 so as to be processed using the threshold matrix M1. Subsequently, in the tone levels are not processed using the threshold matrix M1, the threshold matrices M2 and M3 are related so as not to be used for processing the continuous tone levels.

With respect to the tone levels “0” and “16”, since all the pixels are ON dots or OFF dots, and thus the results are the same for any threshold matrix, the tone levels “0” and “16” may be related to any threshold matrix. Therefore, such situation is illustrated by “−” in the correspondence table 1104. As another example for determining the tone level group, a value determined corresponding to the tone value known as the principal frequency may be selected as a reference (refer to U.S. Pat. No. 511,130).

Subsequently, steps S903 through S911 are repeated to create a threshold matrix one by one. A flow for creating the threshold matrix M1 is described below as an example. The other threshold matrices can be created in a similar manner.

In step S904, a matrix representing the threshold matrix M1 is initialized by filling the matrix M1 with a threshold which outputs no dot for any tone level.

In step S905, in the tone group corresponding to the threshold matrix M1, the brightest tone level is selected. In an input image of a size identical to that of the threshold matrix (here, 4×4), a dot pattern in which the number of dots required for expressing the selected tone level is disposed is determined. At that time, the dot pattern is desirably a dot disposition having good graininess.

How to determine the dot pattern having good graininess representing a certain tone level may be performed by using a publicly known method. Ata position of the threshold matrix M1 corresponding to a position of a dot of the dot pattern, a threshold corresponding to the tone level represented by the dot pattern is to be recorded.

In step S906, the next brightest tone level is subsequently selected among the tone groups to be processed using the threshold matrix M1. Under the condition that all the dots having already been disposed are to be held at the same positions, a dot pattern having the number of dots required for the selected tone level is determined. In other words, new dots are added to a dot pattern representing a tone level brighter than the selected tone level among the tone group corresponding to the threshold matrix M1, thereby determining a dot pattern representing the selected tone level.

It is also desirable that the dot disposition here has the good graininess. The tone group to be processed using the threshold matrix M1 has the good matching to determine a dot disposition having good graininess, as described above. Therefore, a dot pattern having good graininess can be generated by adding dots.

In step S907, a threshold for the tone level selected in step S906 is stored at a position of the threshold matrix M1 corresponding to the positions at which the new dots are added in step S906. As described above, the dots of the next dark tone level is determined while keeping the dots at the bright tone level. In the tone groups to be processed by the threshold matrix M1, the determination is repeated from the brightest tone level 1 to the darkest tone level 15. In step S911, when the processing is completed for all the tone groups to be processed using the threshold matrix M1, the threshold matrix M1 is stored.

Then, the processing for creating the next threshold matrix is performed. The above described processing is performed on all the threshold matrices up to the threshold matrices M2 and M3 and, upon completing creation of the third threshold matrix, creation of the plurality of threshold matrices to be used in the present exemplary embodiment is completed.

FIG. 12 illustrates specific examples of the threshold matrices created according to the flow chart of FIG. 9. All the threshold matrices M1 through M3 determine output values according to such a rule that the dots to be output are converted into ON dots (i.e., black pixels) if the input values are equal to or less than the threshold. Each position of the matrix 1204 is provided with a letter from a through p.

The threshold matrix to be used in the conventional dither method generally stores all the tone values to be input as thresholds. On the other hand, in the present exemplary embodiment, as illustrated in the threshold matrices M1 through M3, each threshold matrix stores not all the tone values but 0 or only the tone values to be processed by each threshold matrix as the thresholds. In the threshold matrices according to the present exemplary embodiment, each threshold matrix is provided with a certain threshold at a plurality of positions of each threshold matrix to process the discrete tone levels.

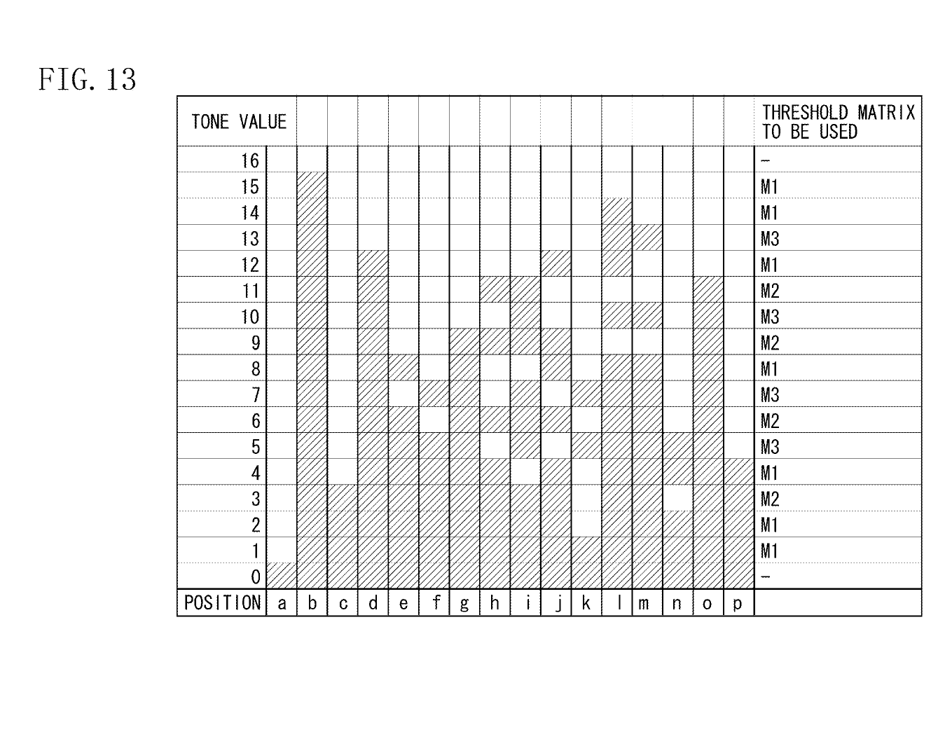

FIG. 13 schematically illustrates a result of the dither method performed on each tone level by using a plurality of threshold matrices according to the present exemplary embodiment.

A vertical axis on the left side indicates a tone level representing input image data and all the input images having a size of 4×4 has the same tone level. A vertical axis on the right side indicates a threshold matrix to be used according to each input value (i.e., each tone level) of the threshold matrices M1, M2, and M3. A horizontal axis indicates a position of each threshold matrix illustrated in the matrix 1204, which corresponds to a pixel position of the input image data. Presence or absence of an output of a dot is represented in an area surrounded by each axis in such a manner that a case where there is an output of a dot is represented by a black color, whereas a case where there is no output of a dot is represented by a white color.

As the tone value becomes smaller, the tone level becomes darker. On the other hand, as the tone value becomes larger, the tone level becomes brighter. For example, in a case where the tone value 5 is input, the threshold matrix M3 is used according to the correspondence table 1104. Each threshold in the threshold matrix M3 is compared with the tone level 5 as the input value for each pixel to determine an output value. In a case where the threshold is larger than the input value 5, the corresponding pixel is converted into ON dot (i.e., black pixel), whereas, in a case where the threshold is smaller than the input value 5, the corresponding pixel is converted into OFF dot (i.e., white pixel). As a result thereof, positions b, d, e, f, g, i, k, l, m, n, and o are converted into black pixels and the other positions are converted into white pixels.

In the conventional dither method using the threshold matrix, there is a limitation that a dot included in a dot pattern representing a brighter tone level should be included in all the tone levels or in the continuous-tone section. However, as it is seen from FIG. 13, in the present exemplary embodiment, dots of tone level brighter than the continuous tone value is not always included in a tone level darker than the continuous tone value.

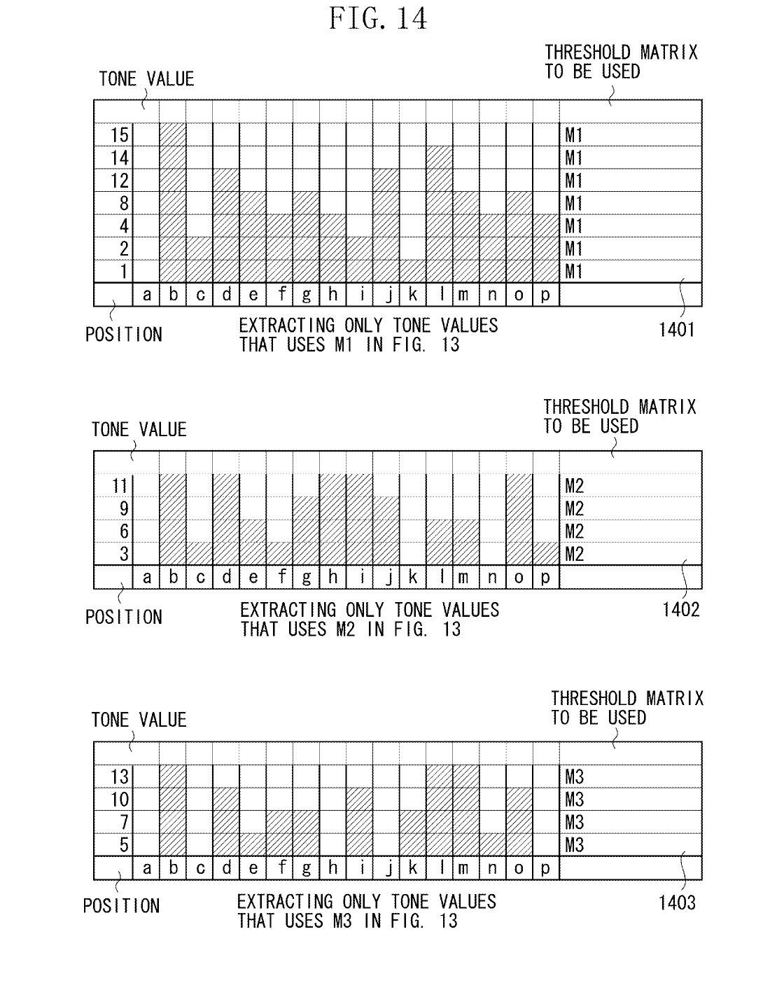

FIG. 14 illustrates an output result of the dots of FIG. 13 for each of the threshold matrices M1, M2, and M3. According to FIG. 14, it is known that, within a tone range to be processed using each of the threshold matrices M1, M2, and M3, dots of the brighter tone level have a limitation to be included in a dot pattern representing the darker tone level. However, since tone values having good match therebetween are set to be processed using the same threshold matrix, the dot pattern representing those tone levels have good graininess.

As described above, the threshold matrix to be used in determining the output value is selected from the plurality of threshold matrices according to the input value. The groups of the tone values (i.e., the tables 1101 through 1103 of FIG. 11) are set so as to be related to one threshold matrix are a combination of tone levels having good match therebetween in order to create a dot disposition having good graininess.

The good match means here that, in two dot patterns having good graininess for representing two tone levels, one of the dot patterns includes all the dots in the other dot pattern having brighter tone level.

As a result thereof, a threshold matrix in the present exemplary embodiment is used to process discontinuous tone values in the input tone values. Accordingly, a dot pattern having good graininess can be generated while reducing a necessary storage capacity according to the dither method using the threshold matrix.

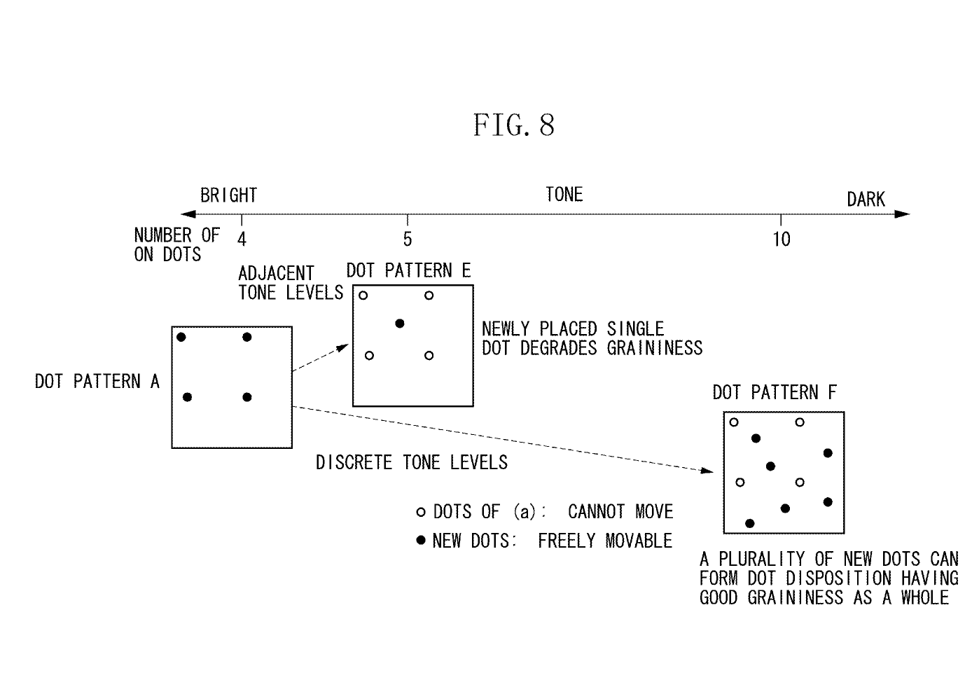

FIG. 8 illustrates a degree of freedom of a dot disposition. In FIG. 8, a dot pattern A represents a tone level 4 in which the number of ON dots is four. A case of determining a dot pattern of a tone level 5 or a tone level 10 is considered while leaving the four dots included in the dot pattern A at positions as they are.

As illustrated in a dot pattern E in FIG. 8, in a case of the dot pattern of the tone level 5 including five dots, the number of dots to be added to the dot pattern A is one. On the other hand, as illustrated in a dot pattern F in FIG. 8, in a case of the dot pattern of the tone level 10 including ten dots, the number of dots to be added to the dot pattern A is six.

In a method in which the same threshold matrix is used, all the ON dots in a dot pattern representing brighter tone level is included in a dot pattern representing darker tone level. Therefore, when a dot pattern is determined for each of the tone level 5 and the tone level 10 using the same threshold matrix as that of the tone level 4, the number of dots that can be added to arbitrary positions is, respectively, one or six.

Since there is only one dot selectable in determining the dot pattern representing the tone level 5 in the dot pattern representing the tone level 5, a dot disposition having good graininess is limited.

On the other hand, in a dot pattern of the tone level including ten dots, the number of dots of which positions can be selected for the tone level 10 is six among the total number of ten dots. Therefore, in the tone level 10, more than half the total number of dots included in the dot pattern can be freely disposed.

As described above, as a ratio of the number of dots of which positions can be determined for the dot pattern of the tone level becomes larger, i.e., as a degree of freedom of the dot disposition becomes larger, a dot pattern having better graininess can be created.

Generally, a difference of the number of dots included in dot patterns is small in a case where the dot patterns are close to each other between the tone levels, whereas a difference of the number of dots included in dot patterns is large in a case where the dot patterns are separated from each other between the tone levels. Therefore, by relating a threshold matrix to the tone levels discretely and separating the distance between the tone levels, more optimum dot pattern can be created in many cases.

In order to cause each threshold matrix to have the above described effect, the tone levels of the tone group corresponding to each threshold matrix may be set periodically by rotation.

As the number N of the threshold matrices becomes larger, an average number of tone levels processed by using a threshold matrix can be reduced. Therefore, the degree of freedom of the dot disposition can be increased so that setting of a dot pattern having better graininess can be expected.

On the other hand, if the number N of the threshold matrices becomes larger, the storage capacity for storing all the threshold matrices becomes larger. A case of expressing tone levels of the number identical to the number of n-bit depth as a result of the halftone processing for converting the input image data representing tone levels of the n-bit depth (i.e., all the tone levels of 2̂n+1) into binary data is considered. At that time, the storage capacity of all the dot patterns can be calculated by the following equation.

Output×number of tones×width of image×height of image=1×(2̂n−1)×W×H=(2̂n−1)WH(bit) (1)

However, the tone levels including only black pixels or only white pixels of which dot disposition is not to be stored are excluded.

On the other hand, the storage capacity required in using N threshold matrices for the input image data of the same tone levels according to the present exemplary embodiment can be calculated by an equation (2).

Storage capacity of one pixel of threshold matrix×the number of threshold matrices×width of image×height of image=n×N×w×H=nNWH(bit) (2)

When making a comparison therebetween, the storage capacity can be saved by the present invention when the (2̂n−1)WH>nNWH is true, i.e., when N<2̂n−1/n is true and the number N of threshold matrices is less than (2̂n−1)/n.

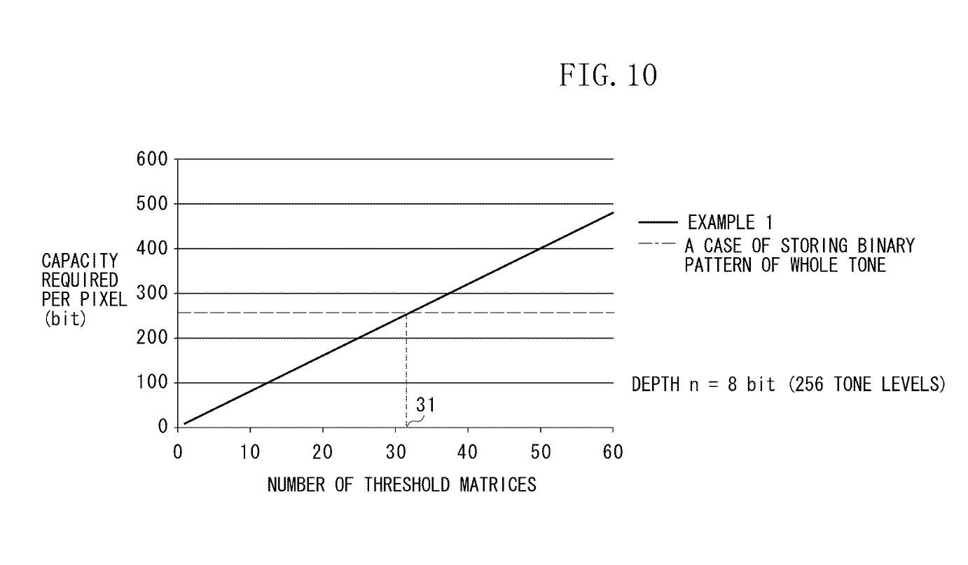

FIG. 10 illustrates an example of a relationship of the storage capacity when n=8. At that time, it can be seen therefrom that the storage capacity can be saved when the number of threshold matrices is equal to or less than 31 for all the 256 tone levels. Actually, the user may select any suitable number of threshold matrices in consideration of various conditions.

In the above described exemplary embodiment, a configuration having one comparator in the halftone processing unit 206 is described. In a second exemplary embodiment, a configuration having a comparator for each one of the threshold matrices is described.

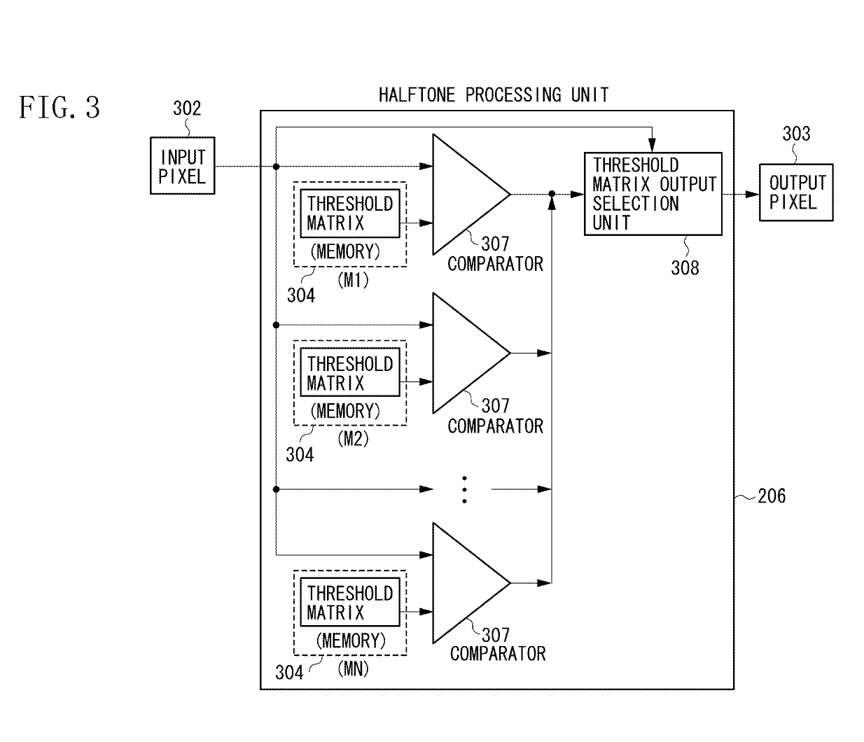

FIG. 3 illustrates a configuration of the halftone processing unit 206 applicable to the second exemplary embodiment. Components similar to those of the first exemplary embodiment are provided with the same numerals and/or symbols and detailed descriptions thereof are omitted here. In FIG. 3, the halftone processing unit 206 includes the number of comparators 307 corresponding to the number of threshold matrices M1 through MN. When an input value representing a pixel to be processed is input, the input value is compared with each of the threshold matrices in parallel.

Thereafter, the threshold matrix output selection unit 308 determines which value is to be employed as an output as a result of the comparison with each threshold matrix according to the input value (i.e., the tone level). The correspondence relationship between each threshold matrix and the input value is similar to that of the first exemplary embodiment.

In the above described exemplary embodiment, the halftone processing in which the output is converted into binary data of ON dots or OFF dots is specifically described. However, a multi-valued halftone processing is also employable. Generally, in the multi-valued halftone processing, when full tone value of the input is R, a multi-valued level capable of being output is m, and a storage threshold at a position (i, j) of a binary halftone processing threshold matrix is Dᵢⱼ, the multi-valued half-tone threshold matrix Tᵢⱼ^{(r)} is expressed as follows.

$${T}_{ij}^{( r )} = int \{ \frac{R}{( m - 1 ) WH} ( {D}_{ij} + rWH + 0.5 ) \} \qquad ( 3 )$$

(r=0, 1, . . . , m−2). Here, int represents “converting into integer”. However, the Tᵢⱼ^{(r)} is used with respect to xᵢⱼ within a range where the input values xᵢⱼ are obtained by

$$\frac{r}{m - 1} R < {x}_{ij} < \frac{( r + 1 )}{m - 1} R . \qquad ( 4 )$$

With the above described conversion, the present invention is applicable also in a case of the multi-valued halftone processing.

The above described relationship between a threshold matrix and tone values processed using the threshold matrix is designed in consideration of matching between tone values. However, even without considering the matching between tone levels, a dot pattern more optimum to a certain tone value can be freely created if the tone levels are spaced away to each other. Therefore, if it is only designed that discontinuous tone levels are included in the tone to be processed by the threshold matrix, it has an effect on the graininess of the dot pattern.

In the above described exemplary embodiment, the correspondence relationships between the N number of threshold matrices and the tone levels are stored in the form of the table for the reference. However, it is also possible to specify the threshold matrix according to the tone levels by performing calculation such as (tone value % N).

In the above described exemplary embodiments, halftone image data for forming an image by a single recording is generated for the same region of a recording medium. However, the present exemplary embodiment can be applied to a multi-path recording method for forming an image by a plurality of times of recording with respect to the same region of the recording medium. The present exemplary embodiment may be carried out in combination with a publicly known method for generating data corresponding to each scanning.

A case where the image forming apparatus records a single color image is described in the above described exemplary embodiments. However, the present exemplary embodiment can also be applied to a case where the image forming apparatus records a color image. In this case, color separation processed data of each color is output from the color separation processing unit 204. The halftone processing is performed on the color separation data of each color to output the result thereof to the image forming apparatus 109.

The present invention can also be realized by supplying a storage medium recording a program code of software which realizes a function of the above described exemplary embodiments to a system or an apparatus. In this case, a computer (or a central processing unit (CPU) or a micro processing unit (MPU)) of the system or the apparatus reads out a program code computer readably stored in the storage medium to execute the program, thereby realizing the function of the above described exemplified embodiments.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2012-076772 filed Mar. 29, 2012, which is hereby incorporated by reference herein in its entirety.

What is claimed is:

1. An image processing apparatus for generating a dot pattern of each tone level so that, in a tone level N, a tone level N+α, and a tone level N+β(α<β), a dot pattern representing the tone level N+β includes all the dots in a dot pattern representing the tone level N and a dot pattern representing the tone level N+α does not include all the dots in the dot pattern representing the tone level N, the apparatus comprising:
an input unit configured to input tone level,
a halftone processing unit configured to perform halftone processing on the input tone level by using a threshold matrix to generate a dot pattern representing the input tone level,
wherein the dot patterns representing the tone level N and the tone level N+β are generated by the halftone processing using a first threshold matrix; and
wherein the dot pattern representing the tone level N+α is generated by the halftone processing using a second threshold matrix different from the first threshold matrix.

2. The image processing apparatus according to claim 1, wherein the tone levels N, N+α, and N+β are determined based on a distance between dots in the dot pattern representing each tone level.

3. An image processing apparatus for performing halftone processing using a plurality of threshold matrices on input image data, the apparatus comprising:
a determination unit configured to determine, by using a threshold matrix according to an input value representing a target pixel in the input image data, a value obtained by quantizing the input value as an output value of the target pixel,
wherein the threshold matrix is used in at least a pair of discontinuous input values.

4. The image processing apparatus according to claim 3, wherein the determination unit selects a threshold matrix to be used from the plurality of threshold matrices according to the input value and determines the output value by quantizing the input value using the selected threshold matrix.

5. The image processing apparatus according to claim 3, wherein the determination unit determines the output value by selecting an output value of the target pixel according to the input value based on a result of quantization by using each of the plurality of threshold matrices with respect to the input value of the target pixel.

6. The image processing apparatus according to claim 4, wherein the determination unit determines the output value based on a table representing the input value and a threshold matrix corresponding thereto.

7. The image processing apparatus according to claim 3, wherein the input value corresponds to any one of the plurality of threshold matrices.

8. The image processing apparatus according to claim 3, wherein a plurality of tone levels corresponding to a first threshold matrix in the plurality of threshold matrices are periodical.

9. An image processing apparatus for generating a dot pattern by halftone processing using a plurality of threshold matrices, the apparatus comprising:
a first tone group including at least a pair of discontinuous tone levels; and
a second tone group including tone levels different from the tone levels included in the first tone group;
wherein, in each of the first tone group and the second tone group, a dot pattern representing each tone level includes all the dots representing brighter tone level.

10. The image processing apparatus according to claim 9, wherein the number of the plurality of threshold matrices is less than (2̂n−1)/n where the number of bits of the input value is n.

11. The image processing apparatus according to claim 3, wherein the threshold matrix is a dispersion type.

12. The image processing apparatus according to claim 11, wherein the threshold matrix has a blue noise characteristic.

13. The image forming apparatus according to claim 1, wherein an image is formed based on a dot pattern generated by the image processing apparatus.

14. The image forming apparatus according to claim 13, wherein the image forming apparatus is an ink jet printer.

15. The image forming apparatus according to claim 14, wherein image forming apparatus performs multi-path printing.

16. A computer-readable storage medium containing a computer-executable program for causing a computer, by reading and implementing the program, to function as the image processing apparatus according to claim 1.

17. An image processing method for generating a dot pattern of each tone level so that, in a tone level N, a tone level N+α, atone level N+β (α<β), a dot pattern representing the tone level N+β includes all the dots in the dot pattern representing the tone level N and a dot pattern representing the tone level N+α does not include all the dots in the dot pattern representing the tone level N, the method comprising:
generating, by a halftone processing unit, a dot pattern representing a input tone level by performing halftone processing using a threshold matrix on the input tone level;
generating the dot patterns representing the tone level N and the tone level N+β by halftone processing using a first threshold matrix; and
generating the dot pattern representing the tone level N+α by halftone processing using a second threshold matrix different from the first threshold matrix.

18. An image processing method for performing halftone processing using a plurality of threshold matrices on input image data, the method comprising:
determining by a determination unit an output value of a target pixel by quantizing an input value by using a threshold matrix selected according to the input value representing the target pixel in the input image data; and
wherein the threshold matrix is used in at least a pair of discontinuous input values.

19. An image processing method for generating a dot pattern by halftone processing using a plurality of threshold matrices, the method comprising:
a first tone group including at least a pair of discontinuous tone levels; and
a second tone group including tone levels different from the tone levels included in the first tone group;
wherein, in the first tone group and the second tone group, a dot pattern representing each tone level includes all the dots representing a brighter tone level.
